(19) United States
(12) Patent Application Publication
(10) Pub. No.: US 2001/0020850 A1
(43) Pub. Date: Sep. 13, 2001

(54) Capacitance measurement circuit with digital output

(76) Inventors: Robert B. McIntosh, Alexandria, VA (US); Steven R. Patterson, Concord, NC (US)

Correspondence Address: Robert B. McIntosh, 309 Vassar Road, Alexandria, VA, 22314, US

(21) Appl. No.: 09/816,551

(22) Filed: Mar. 24, 2001

Related U.S. Application Data
(63) Continuation-in-part of application No. 09/482,119, filed on Jan. 13, 2000.
Application No. 09/482,119 is a division of application No. 09/037,733, filed on Mar. 10, 1998, now Pat. No. 6,151,967.

(51) Int. Cl. H01H 73/00

(52) U.S. Cl. 324/519; 361/115

(57) ABSTRACT

A capacitance measurement circuit detects a change in capacitance between a variable capacitor and a fixed reference capacitor in a bridge network and provides feedback current to null-balance the bridge. An error signal is amplified at high gain by a differential integrator having an output that is converted to a high-frequency stream of digital pulses of constant amplitude and width. The pulse stream is integrated to provide a voltage to control feedback current used to balance the bridge. The average pulse density per unit time, or the frequency of the digital pulses, is linearly proportional to a change in capacitance of said variable capacitor to high accuracy over a wide dynamic range.

### CROSS-REFERENCE TO RELATED APPLICATIONS

This application is a continuation-in-part of divisional application Ser. No. 09/482,119, Jan. 13, 2000, of application Ser. No. 09/037,733 of Mar. 10, 1998, now U.S. Pat. No. 6,151,967. This application also relates to co-pending application Ser. No. 09/794,198, filed on Feb. 27, 2001. Each of the foregoing applications is incorporated by reference in its entirety. All of the applications are assigned to the same assignee as the present application.

### GOVERNMENT RIGHTS

This invention was made with Government support under contract N00024-97-C-4157 from the Naval Sea Systems Command. The Government has certain rights to this invention.

### FIELD OF THE INVENTION

The present invention relates in general to electronic circuits used to measure capacitance and more specifically to precision, low-noise, capacitance measurement circuits with a linear response for a large change of capacitance.

### BACKGROUND OF THE INVENTION

The capacitance measurement circuit of the present invention can be used to provide a digital output for precision, capacitance-based transducers. A digital output can be transmitted and decoded with more accuracy than an analog signal when the transmission path is long and noisy. Another advantage is that electrical isolation can be accomplished using inexpensive optical isolation IC's. Still another advantage is the elimination of the requirement for a precision analog-to-digital converter (ADC) in sensor systems employing digital signal processors.

The circuit of this invention also has all the advantages of “Linear Capacitance Measurement Circuit” of co-pending application Ser. No. 09/794,198. It enhances the linearity, resolution, and dynamic range of capacitance transducers used to sense force, pressure, strain, vibration, acceleration, gravity, sound, mechanical displacement, electric charge, radiation, and fluid flow.

Many electronic circuits have been devised to transduce a change of capacitance of a variable capacitor, but none provide a linear output for the large changes in capacitance of variable-area capacitors of U.S. Pat. No. 6,151,967. The performance of many capacitance transducers can be enhanced if a capacitance measurement circuit is available that has the following combination of advantages:

a. a digital output that is linear with large changes of capacitance;

b. a measurement bandwidth that extends from DC to a predetermined cutoff frequency;

c. a bridge network in which an electrode of variable capacitors is grounded;

d. a low-impedance bridge that minimizes the thermal noise of passive components and the current noise of amplifying means;

e. a bridge that minimizes noise and errors due to timing variations of an excitation waveform;

f. a circuit in which DC stability is established by high-gain current feedback;

g. a bridge that minimizes signal division by fixed elements and uses a majority of the time during an excitation cycle to develop a measurement signal;

h. a feedback circuit in which low-pass filtering ahead of amplification reduces input signal swings and avoids amplification of high bridge excitation frequencies;

i. the linearity requirement is relaxed for an analog-to-digital converter operating within a feedback loop.

The present invention was developed to provide a capacitance measurement circuit with the above advantages to enhance the performance of capacitance transducers.

### SUMMARY OF THE INVENTION

A general object of the present invention is to provide an improved capacitance measurement circuit with a digital output that is linear for large changes of capacitance compared to prior art capacitance measurement circuits.

In accordance with one embodiment of this invention, a capacitance measurement circuit detects a change in capacitance between a variable capacitor and a fixed reference capacitor in a bridge network and provides feedback current to null-balance the bridge. An error signal is amplified at high gain by a differential integrator having an output that is converted to a high-frequency stream of digital pulses of constant amplitude and width. The pulse stream is integrated to provide a voltage to control feedback current used to balance the bridge. The average pulse density per unit time, or the frequency of the pulses, is linearly proportional to a change in capacitance of said variable capacitor to high accuracy over a wide dynamic range.

If the analog-to-digital pulse conversion function is performed by a sigma-delta modulator, also commonly called a delta-sigma modulator, a digital output can be converted into a binary weighted digital output by a digital filter with decimation. When the analog-to-digital pulse conversion function is performed by a voltage-to-frequency type of ADC, the output pulses can be counted in a synchronized time gate to provide a digital word corresponding to a change of the variable capacitor.

The capacitance measurement circuit of the present invention can detect small changes of variable-gap capacitance transducers and large capacitance changes of variable-area capacitors of U.S. Pat. No. 6,151,967 used to measure physical effects.

### DESCRIPTION OF THE DRAWINGS

Further objects and advantages of the present invention will become apparent from the following description of the preferred embodiments when read in conjunction with the appended drawings, wherein like reference characters generally designate similar parts or elements with similar functions, and in which:

FIG. 1 is a circuit diagram of a bridge network included in a preferred embodiment of a capacitance measurement circuit of the present invention;

FIGS. 2A-D are timing diagrams for electrical signals of the bridge network of FIG. 1;

FIGS. 3A-B are timing diagrams for a transposed bridge network included in a second embodiment of a capacitance measurement circuit of the present invention;

FIG. 4 is a simplified circuit diagram of a preferred embodiment of a capacitance measurement circuit of the present invention;

FIG. 5 is a simplified circuit diagram of a differential integrator included in one embodiment of the capacitance measurement circuit of FIG. 4.

FIG. 6 is a simplified circuit diagram of a precision pulse generator included in one embodiment of the capacitance measurement circuit of FIG. 4.

### DETAILED DESCRIPTION OF PREFERRED EMBODIMENTS

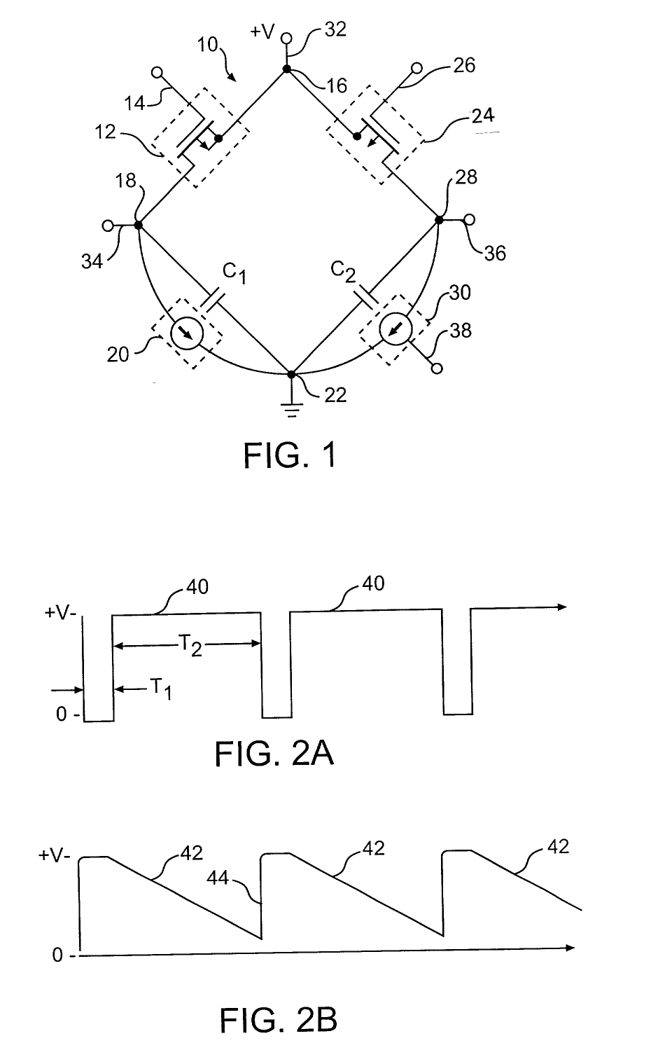

A bridge network included in a preferred embodiment of a capacitance measurement circuit of the present invention is generally shown by reference numeral 10 in FIG. 1. A first isolation means 12 with control terminal 14 is connected between a first node 16 and a second node 18, and a first capacitor C₁ and current sourcing means 20 connected in parallel between node 18 and a third node 22, thereby forming a first side of bridge network 10. A second isolation means 24 with control terminal 26 is connected between node 16 and a fourth node 28, and a second capacitor C₂ and voltage-controlled current sourcing means 30 connected in parallel between node 22 and node 28, thereby forming a second side of bridge network 10. A voltage +V is connected to terminal 32 connected to node 16, and a ground or reference potential is connected to node 22. Bridge output terminals 34 and 36 are connected to nodes 18 and 28 respectively and control terminal 38 is connected to voltage-controlled current sourcing means 30.

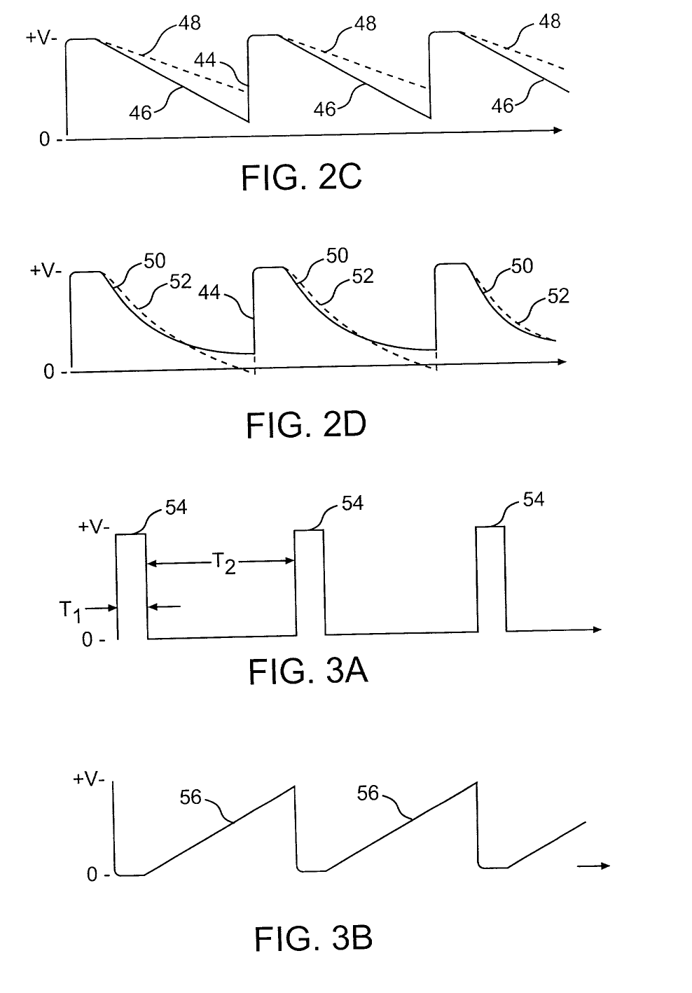

The operation of bridge network 10 is described with reference to timing diagrams of FIGS. 2A-D. FIG. 2A shows a train of periodic pulses 40 of voltage amplitude +V applied to control terminals 14 and 26 of isolation means 12 and 24 respectively. During time T₁, a low voltage at terminals 14 and 26 cause isolation means 12 and 24 to conduct and capacitors C₁ and C₂ to rapidly charge to voltage +V applied to terminal 32. At the end of time T₁, pulse 40 of amplitude +V cause isolation means 12 and 24 to stop conducting to allow voltage +V across capacitors C₁ and C₂ to decrease at a rate determined by the magnitude of current sunk by current sourcing means 20 and by voltage-controlled current sourcing means 30 respectively. FIG. 2B shows the resulting voltage waveform 42 across capacitor C₁ at node 18 and FIG. 2C shows voltage waveform 46 across C₂ at node 28 when capacitors C₁ and C₂ are of equal value and when current sourcing means 20 and 30 sink identical current. For this balanced condition, the periodic voltage at nodes 18 and 28 will be substantially equal and waveform 46 of FIG. 2C will be similar to waveform 42 of FIG. 2B. If the value of capacitor C₂ increases when current sourcing means 20 and 30 sink identical currents, a new voltage waveform 48 develops at node 28 with a higher average value than waveform 46.

A preferred embodiment of a capacitance measurement circuit of this invention is based upon using the difference between a running average of the periodic voltage at nodes 18 and 28 of FIG. 1 as an error signal in a negative feedback circuit arrangement. This error signal is amplified at high-gain and converted to a digital pulse stream that is used to provide a control voltage to current sourcing means 30. When C₂ is greater that C₁, a voltage change ΔV at terminal 38 causes current sunk by voltage-controlled current sourcing means 30 to increase by Δi to force waveform 48 of FIG. 2C to have the general contour of waveform 46. This change ΔV at terminal 38 is proportional to ΔC₂/C₂ and remains substantially linear for large values of ΔC₂.

Current sourcing means 20 can comprise a common resistor, a switched-capacitor current source, a current source, a current conveyor, or a fixed voltage-to-current convertor. Voltage-controlled current sourcing means 30 can be a resistor, a voltage-controlled switched-capacitor current source, a voltage-controlled current source, a voltage-controlled current conveyor, or a voltage programmed current convertor.

If current sourcing means 20 in bridge network 10 is replaced by a resistor, the voltage on C₁ discharges exponentially to an asymptote determined by a reference potential at node 22 during time T₂ and the voltage waveform at node 18 comprises a periodic waveform of exponentially decaying pulses 50 of FIG. 2D. Waveform 52 is representative of a periodic waveform at node 28 for a 100% change in capacitor C₂ when voltage-controlled current sourcing means 38 is replaced by a resistor of equal value to a resistor replacing current sourcing means 20 and for a feedback circuit having a closed-loop of gain of 0.5 Vₚ/C₁, where Vₚ is voltage step 44 of pulse 50 of FIG. 2D.

The advantages of the present invention are realized by detecting and actively nulling the difference between running averages of the periodic voltage waveforms at nodes 18 and 28 of circuit 10. The exact contour of the waveforms need not be precisely matched.

In bridge network 10 of FIG. 1, capacitors C₁ and C₂ are discharged from an initial voltage of substantially +V. However, all the advantages of the capacitance measurement circuit of the present invention can be realized if capacitors C₁ and C₂ in a transposed bridge network are rapidly discharged during time T₁ and charged towards a voltage +V during time T₂. Such a transposed bridge network has the identical construction of circuit 10 of FIG. 1, only the polarity of isolation means 12 and 24 and current sourcing means 20 and 30 is reversed and terminal 32 is returned to a reference potential applied to node 22. In the transposed bridge network, voltage waveform 54 of FIG. 3A is applied to control terminals 14 and 26 of isolation means 12 and 24 respectively which may be n-channel MOSFETs instead of the p-channel MOSFETs shown in FIG. 1. Periodic waveform 56 of FIG. 3B is generated at nodes 18 and 28 when capacitors C₁ and C₂ are of equal value and when current sourcing means 20 and 30 source identical current. When C₂ is not equal to C₁, the voltage difference between nodes 18 and 28 provides an error signal that can be used to null-balance the transposed circuit arrangement of bridge network 10 in accordance with this invention.

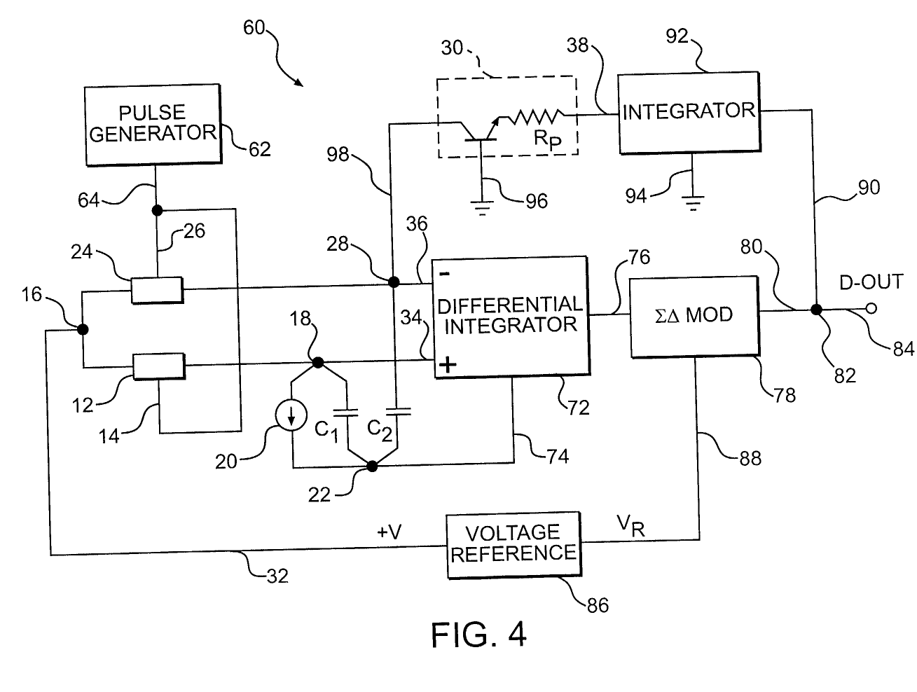

FIG. 4 shows a preferred embodiment of a capacitance measurement circuit of the present invention generally shown by reference numeral 60. Circuit 60 is configured to measure the difference in capacitance between grounded capacitors C₁ and C₂, where C₂ is a variable capacitor. Capacitor C₁ may be a fixed reference capacitor or a second variable capacitor of a differential capacitance transducer. Pulse generator 62 is connected by output terminal 64 to control terminals 14 and 26 of isolation means 12 and 24 respectively. Isolation means 12 is connected between a first node 16 and a second node 18, and a first capacitor C₁ and current sourcing means 20 connected in parallel between node 18 and a third node 22 connected to a reference potential. Second isolation means 24 is connected between node 16 and a fourth node 28 and a second capacitor C₂ is connected between node 28 and node 22. A first bridge output terminal 34 is connected between node 18 and an input of a differential integrator 72 and a second bridge output terminal 36 is connected between node 28 and an input of opposing polarity of differential integrator 72. A reference voltage terminal 74 of differential integrator 72 is connected to node 22. An output of differential integrator 72 is connected to an inverting input terminal 76 of a sigma-delta modulator 78 and an output terminal 80 of modulator 78 is connected to node 82 connected to digital output terminal 84. Voltage reference 86 with a first output of voltage +V is connected by terminal 32 to first node 16. A second output of voltage reference 86 with a voltage V_{R}, generally ≦+V, is connected to an external reference voltage input terminal 88 of modulator 78. Node 82 is connected to an inverting input terminal 90 of a lossy integrator 92 and reference terminal 94 of integrator 92 is connected to a reference potential which may be a bias voltage. An output of integrator 92 is connected to input terminal 38 of voltage-controlled current sourcing means 30 and reference terminal 96 of current sourcing means 30 is connected to a reference potential that may be an alternative bias voltage. Output terminal 98 of current sourcing means 30 is connected to fourth node 28.

The function of voltage-controlled current sourcing means 30 in FIG. 4 is shown being performed by a simple transistor current conveyor with current programming resistor Rₚ. The function of this non-inverting current sourcing means could alternately be performed by a resistor that serves as a two-terminal transconductance transducer. If a non-inverting switched-capacitor integrator is selected for lossy integrator 92, an inverting current sourcing means 30 is required to obtain negative current feedback. In this case, a simple transistor current source could be used with an emitter or source resistor Rₚ connected to terminal 96, a base or gate connected to terminal 38, and a collector or drain connected to terminal 98.

Circuit 60 includes bridge network 10 and generally operates according to the principles described for FIG. 1. Pulse generator 62 with an output of periodic pulses 40 of FIG. 2A generates voltage waveform 42 of FIG. 2B across capacitor C₁ at node 18 and voltage waveform 46 of FIG. 2C across C₂ at node 28 when capacitors C₁ and C₂ are of equal value and when current sourcing means 20 and 30 sink identical current. If current sourcing means 20 and 30 are resistors, the waveforms at nodes 18 and 28 are trains of exponentially decaying pulses of with a general contour of waveform 50 of FIG. 2D.

Differential integrator 72 amplifies at high gain the error difference between running averages of voltage waveforms at nodes 18 and 28. The output voltage of differential integrator 72 controls the density of an output stream of pulses of constant amplitude and width from modulator 78. Modulator 78 is an over sampling sigma-delta modulator that includes a high-frequency, 1-bit feedback ADC. A change in a running time integral of the output pulses of modulator 78 is linearly proportional to the difference ΔC between capacitors C₁ and C₂. A voltage-to-frequency converter (VFC) or another type of ADC can be used in circuit 60 when the ADC provides a stream of output pulses of constant amplitude and width and when a time average of the number of output pulses is proportional to an input voltage of the ADC.

The output voltage of integrator 92 controls the magnitude of current sunk by current sourcing means 30 from node 28 to null-balance the running averages of the periodic voltages at nodes 18 and 28. The gain of lossy integrator 92 is generally limited to values near unity as the integrator performs a voltage-to-current transconductance function. The high open-loop gain of circuit 60 is generally provided by differential integrator 72 ahead of voltage-to-pulse rate conversion for the circuit arrangement of FIG. 4.

A bias voltage applied at terminal 94 of integrator 92, at terminal 96 of current sourcing means 30, or to a terminal of differential integrator 72, not shown, can be used to adjust the quiescent pulse density or pulse frequency at terminal 80 of modulator 78 and at the digital output terminal 84. When Capacitor C₂ increases by ΔC, the output voltage of integrator 92 decreases by −ΔV to cause current sourcing means 30 to sink an additional current Δi to maintain bridge balance. A change in voltage ΔV at the output of integrator 92 for a change in capacitance ΔC can be expressed as:

$$Δ V \begin{matrix}= - {Ki}_{o} {R}_{p} \frac{Δ C}{C} \\ = - {KV}_{p} \frac{Δ C}{C}\end{matrix}$$

where:

K=T₂/(T₁+T₂) the duty cycle of the capacitor discharge period,

iₒ=the quiescent current sunk by voltage-controlled current sourcing means 30,

Vₚ=a voltage proportional to the magnitude of voltage step 44 of FIG. 2B,

and Rₚ is a current programming resistor of current sourcing means 30.

Because ΔV is linearly proportional to a running time integral of the pulses at terminal 84, the average pulse density or pulse frequency at output terminal 84 is linearly proportional to ΔC₂ to high accuracy over a wide dynamic range.

### Differential Integrator Circuit Embodiment

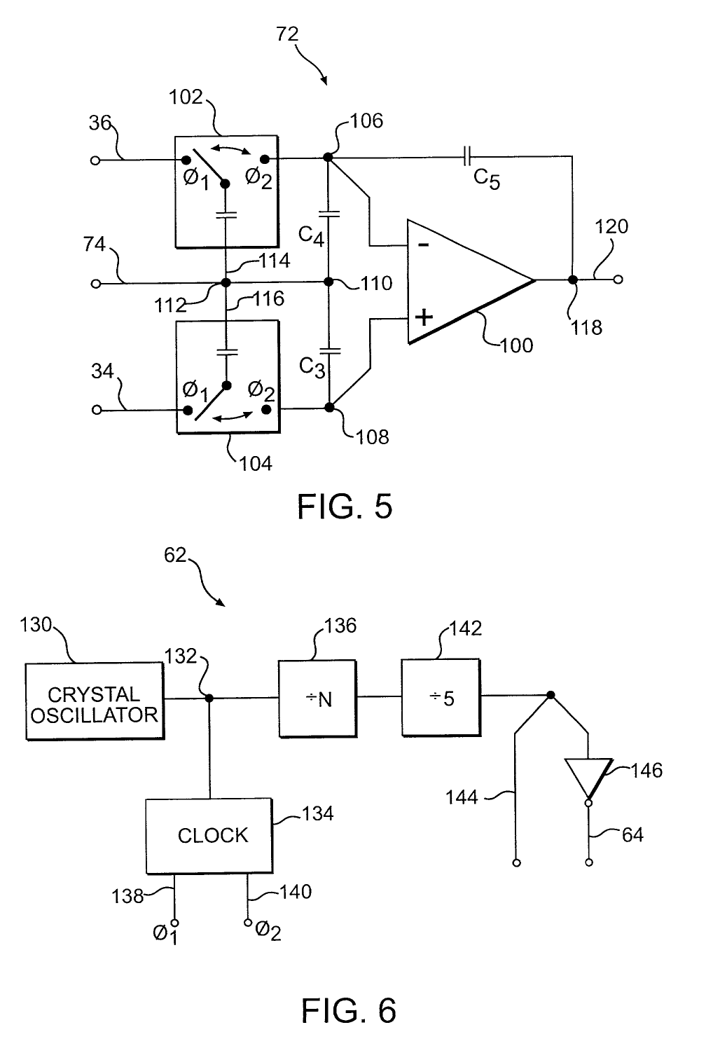

FIG. 5 is a simplified schematic of one type of differential integrator, generally shown by reference numeral 72, that can be used with capacitance measuring circuit 60 of FIG. 4, as well as with its transposed circuit arrangement. Differential integrator 72 includes amplifier 100, single-pole double-throw (SPDT) switched capacitors 102 and 104, and capacitors C₃, C₄, and C₅. Switched capacitor 102 is connected between bridge output terminal 36 and node 106 connected to one side of capacitor C₄, to one side of capacitor C₅, and to an inverting input terminal of amplifier 100. Switched capacitor 104 is connected between bridge output terminal 34 and node 108 connected to one side of capacitor C₃ and to a non-inverting terminal of amplifier 100. The second side of capacitors C₃ and C₄ are connected to node 110 connected to node 112 connected to the reference terminals 114 and 116 of switched capacitors 102 and 104 respectively. Node 112 is connected to terminal 74 connected to node 22 of circuit 60 of FIG. 4. A second side of capacitor C₅ and an output of amplifier 100 is connected to node 118 connected to output terminal 120 connected to terminal 76 of modulator 78 of circuit 60 of FIG. 4.

Capacitor C₄ in differential integrator circuit 72 can be relocated to replace feedback stabilization capacitor C₅ to form a well-known switched-capacitor differential integrator circuit, but this arrangement has a disadvantage. Capacitor C₅ can be smaller than low-pass filter capacitor C₄ since only a small value of capacitor C₅ is generally required to stabilize the feedback loop of circuit 60 of FIG. 4. A smaller feedback capacitor C₅ increases the open-loop gain of differential integrator 72 to enhance the DC stability of circuit 60. Switched capacitors 102 and 104 are SPDT, CMOS circuits that are conventionally repetitively switched by two-phase, non-overlapping clock pulses of phase φ₁ and phase φ₂, not shown. The frequency at which the switches are operated is required to be greater than the excitation frequency of pulse generator 62. Switched capacitors 102 and 104 can be replaced by equivalent resistors in a totally analog circuit arrangement of differential integrator 72 for certain precision low-frequency capacitor measurements.

Low-pass filtering of the periodic voltages at nodes 18 and 20 of circuit 60 of FIG. 4 before amplification reduces the voltage swing at the inputs of amplifier 100 and avoids the requirement to amplify bridge excitation frequencies. The high-frequency cutoff of the low-pass filters that include switched capacitor 102 and capacitor C₄ and switched capacitor 104 and capacitor C₃ are generally selected to be equal at a value below the excitation frequency of pulse generator 62.

### Pulse Generator Circuit Arrangement

FIG. 6 is a simplified schematic of a precision pulse generator generally shown by reference numeral 62 that can be used with the preferred embodiment of capacitance measuring circuit 60 of FIG. 4, and in its transposed circuit arrangement, when differential integrator 72 is generally of the switched-capacitor type shown in FIG. 5. A crystal oscillator 130 is connected to node 132 connected to a clock 134 and to divide-by-N counter 136. Output terminals 138 and 140 of clock 138 provide non-overlapping, out-of-phase pulses of phase φ₁ and phase φ₂ respectively to operate SPDT switched capacitors 102 and 104 of differential integrator 72 of FIG. 5 and any switched capacitors included in lossy integrator 92, current sourcing means 20, or voltage-controlled current sourcing means 30 of circuit 60 of FIG. 4. Divide-by-N counter 136 is connected to divide-by-five ripple counter 142 to provide output of pulses 54 with a 20% duty cycle as shown in FIG. 3A. Ripple counter 142 is connected to terminal 144 and to inverter 146 with an output connected to terminal 64 of circuit 60 of FIG. 4. Output terminal 64 provides a waveform of pulses 40 shown in FIG. 2A. For a transposed arrangement of circuit 60 of FIG. 4, output terminal 144 is connected instead to terminal 64 of circuit 60.

### Other Arrangements of the Preferred Embodiment

For capacitance transducers and differential capacitive transducers having very small full-scale capacitance changes, the closed-loop gain of circuit 60 of FIG. 4. can be increased by connecting a constant current source or a resistor between nodes 28 and 22 to sink additional current from node 28. If capacitor C₂ of circuit 60 has a low quiescent value, a higher value reference capacitor C₁ can be selected if current sourcing means 30 is biased to sink proportionally more current. Alternately, the value of C₁ can be increased to provide a lower quiescent pulse frequency at terminal 84 when it is desirable to increase the dynamic range limits of modulator 78. Isolation means 12 and 24 of circuit 60, and its transposed circuit, can include BJT, JFET, CMOS, MOSFET, and other types of electrical switches.

For another embodiment of the capacitance measuring circuit of the present invention, the on-off function of isolation means 12 and 24 of circuit 60 of FIG. 4 is performed by a two-terminal isolation means such as: PN-junction diodes, Schottky diodes, or base-to-collector connected transistors. For this circuit arrangement, output terminal 64 of pulse generator 62 is connected to node 16 instead of terminal 32 of voltage reference 86. Terminal 32 can be connected to pulse generator 62 to provide a precision voltage +V to establish the amplitude of pulse 40 of FIG. 2A or of pulse 44 of FIG. 3A for a transposed arrangement of circuit 60.

### Transposed Circuit Embodiment

A transposed circuit embodiment of circuit 60 of FIG. 4 has the identical construction and same circuit elements. The polarity of isolation means 12 and 24 and current sourcing means 20 and 30 are reversed. Pulse generator 62 of FIG. 4 provides output pulses 54 of FIG. 3A that allow capacitors C₁ and C₂ to charge toward voltage +V during time T₂ as shown by waveform 56 of FIG. 3B. In the transposed circuit, the output voltage of differential integrator 72 increases positively for increases in capacitor C₂. To achieve negative feedback, the output of differential integrator 72 is connected to a non-inverting terminal of modulator 78, not shown in FIG. 5.

While this invention has been described with reference to illustrative embodiments, various changes and modifications can be made to the disclosed embodiments without deviating from the concepts and scope of this invention. The full scope of this invention should be determined by the appended claims and their legal equivalents, rather than by the disclosed embodiments.

What is claimed is:

1. A capacitance measurement circuit with a digital output that measures a difference in capacitance between a first and a second capacitor comprising:
a. a first isolation means connected between a first node and a second node, and said first capacitor and a current sourcing means connected in parallel between said second node and a third node connected to a reference potential;
b. a second isolation means connected between said first node and a fourth node, and said second capacitor connected between said third mode and said fourth node;
c. said first node connected to a voltage source more positive than said reference potential and a generator of periodic pulses connected to control terminals of said first and said second isolation means;
d. a first input of a differential integrator connected to said second node and a second input of opposing polarity of said differential integrator connected to said fourth node;
e. said differential integrator connected to an analog-to-digital pulse converter with an output of pulses of constant amplitude and width and an average number of said pulses proportional to an input voltage of said converter;
f. said output of said converter connected to an integrating circuit connected to a control terminal of a voltage-controlled current sourcing means connected to said third node, whereby current fed back to said third node maintains a running average of a periodic voltage at said third node substantially equal to a running average of a periodic voltage at said second node.

2. The capacitance measurement circuit of claim 1 wherein said current sourcing means is selected from the group consisting of a resistor, a switched-capacitor current source, a current source, a current conveyor, and a fixed voltage-to-current convertor.

3. The capacitance measurement circuit of claim 1 wherein said voltage-controlled current sourcing means is selected from the group consisting of a resistor, a voltage-controlled switched-capacitor current source, a voltage-controlled current source, a voltage-controlled current conveyor, and a voltage-programmed current convertor.

4. The capacitance measurement circuit of claim 1 wherein said first and said second isolation means is selected from the group consisting of a BJT switch, a JET switch, a CMOS switch, and a MOSFET switch.

5. The capacitance measurement circuit of claim 1 wherein said first and said second isolation means is a two-terminal isolation means selected from the group consisting of a PN-junction diode, a Schottky diode, and a base-to-collector connected transistor and input terminals of said isolation means are connected to said first node.

6. The capacitance measurement circuit of claim 1 wherein said analog-to-digital pulse converter is a sigma-delta modulator.

7. The capacitance measurement circuit of claim 1 wherein said analog-to-digital pulse converter is a voltage-to-frequency converter.

8. The capacitance measurement circuit of claim 1 wherein said second capacitor is a variable capacitor.

9. A capacitance measurement circuit with two-terminal isolation means that measures a difference in capacitance between a first capacitor and a second capacitor comprising:
a. a generator of periodic pulses connected to a first node connected to a first terminal of a first and a second isolation means, and said first node connected to a voltage source more positive than a reference potential;
b. a second terminal of said first isolation means connected to a second node, and said first capacitor and a current sourcing means connected in parallel between said second node and a third node connected to said reference potential;
c. a second terminal of said second isolation means connected to a fourth node and said second capacitor connected between said third mode and said fourth node;
d. a first input of a differential integrator connected to said second node and a second input of opposing polarity of said differential integrator connected to said fourth node;
e. said differential integrator connected to an analog-to-digital pulse converter with an output of pulses of constant amplitude and width and an average number of said output pulses proportional to an input voltage of said converter;
f. said output of said converter connected to an integrating circuit connected to a control terminal of a voltage-controlled current sourcing means connected to said third node.

10. The capacitance measurement circuit of claim 9 wherein said current sourcing means is elected from the group consisting of a resistor, a switched-capacitor current source, a current source, a current conveyor, and a fixed voltage-to-current convertor.

11. The capacitance measurement circuit of claim 9 wherein said voltage-controlled current sourcing means is selected from the group consisting of a resistor, a voltage-controlled switched-capacitor current source, a voltage-controlled current source, a voltage-controlled current conveyor, and a voltage-programmed current convertor.

12. The capacitance measurement circuit of claim 9 wherein said first and said second isolation means are selected from the group consisting of a PN junction diode, a Schottky diode, and a base-to-collector connected transistor.

13. The capacitance measurement circuit of claim 9 wherein said analog-to-digital pulse converter is a sigma-delta modulator.

14. The capacitance measurement circuit of claim 9 wherein said analog-to-digital pulse converter is a voltage-to-frequency converter.

15. The capacitance measurement circuit of claim 9 wherein said second capacitor is a variable capacitor.
